(19) United States
(12) Patent Application Publication
(10) Pub. No.: US 2021/0096709 A1
(43) Pub. Date: Apr. 1, 2021

(54) Electronic Board Eraser and Controlling Method Thereof for Setting Erasing Area

(71) Applicant: EGALAX_EMPIA TECHNOLOGY INC., Taipei City (TW)

(72) Inventor: SHANG-TAI YEH, Taipei City (TW)

(21) Appl. No.: 17/118,753

(22) Filed: Dec. 11, 2020

Related U.S. Application Data
(63) Continuation-in-part of application No. 16/201,442, filed on Nov. 27, 2018.
(60) Provisional application No. 62/591,235, filed on Nov. 28, 2017.

(30) Foreign Application Priority Data
Dec. 11, 2019 (TW) 108145395

(51) Int. Cl. G06F 3/0484; G06F 3/0488; G06F 3/041; G06F 3/0354

(52) U.S. Cl. CPC G06F 3/0484; G06F 3/04883; G06F 3/03545; G06F 3/0414; G06F 3/04166

(57) ABSTRACT

A method for setting erasing area is provided. The method comprising: receiving an attitude of an electronic board eraser relative to a touch screen and touch pressure values; determining whether at least one corner of an wiping surface of the electronic board eraser contacts the touch screen; and deciding properties of an erasing area if it is determined that at least one corner of the wiping surface of the electronic board eraser contacts the touch screen.

### CROSS REFERENCE TO RELATED APPLICATIONS

This application claims priority to Taiwan patent application, No. 108145395, filed on Dec. 11, 2019 and is a continuation-in-part application of U.S. patent application Ser. No. 16/201,442, filed on Nov. 27, 2018 which claims priority to U.S. patent application, 62/591,235, filed on Nov. 28, 2017, the disclosures of which are incorporated herein by reference.

### BACKGROUND OF THE INVENTION

### 1. Field of the Invention

The present invention relates to the field of electronic board eraser, and more particularly, to an electronic board eraser and system thereof of which using experience is like that of a traditional eraser.

### 2. Description of the Prior Art

Blackboards or whiteboards are common tools used in traditional teaching. Users can use marker to write on the whiteboard and use eraser to erase marker's handwriting. Some manufacturers have made electronic whiteboard, which allows users to use stylus to move on it. The electronic whiteboard can sense tip position of stylus and display handwriting on electronic whiteboard to simulate the writing of the marker on the whiteboard. When users want to erase a part of the electronic whiteboard, settings of the stylus need to be changed, switching the marker mode to the eraser mode. However, compared with the traditional eraser, tip area of stylus is very small and is unable to erase a large area of mark. This is difficult for users to make use of the electronic whiteboard. Accordingly, it is necessary to have a device, which can simulate a traditional eraser, so that users can easily erase the larger area of the electronic whiteboard.

When using a traditional board eraser to wipe a blackboard, user usually uses an edge or a corner of the traditional board eraser to erase a smaller area and to leave surrounding area untouched. If an electronic board eraser having a larger wiping surface is in use, similar aforementioned user experience is required. In addition to use the entire wiping surface of the electronic board eraser, it is also desired to use an edge or a corner of the electronic board eraser for erasing a smaller area. When using the edge or the corner of the electronic board eraser, it is also desired to control erasing effects according to the pressure inputted to the electronic board eraser.

### SUMMARY OF THE INVENTION

The method and system provided by the present application is used to set erasing area. People can use an electronic board eraser by contacting entire wiping surface to the touch screen for wiping out large area. User can also use an edge or a corner of the electronic board eraser to wipe a smaller area. When doing so, user can set erasing probability by adjusting pressure to the electronic board eraser.

According to an embodiment of the present invention, a method for setting erasing area is provided. The method comprising: receiving an attitude of an electronic board eraser relative to a touch screen and touch pressure values; determining whether at least one corner of an wiping surface of the electronic board eraser contacts the touch screen; and deciding properties of an erasing area if it is determined that at least one corner of the wiping surface of the electronic board eraser contacts the touch screen.

In one embodiment, in order to more quickly for receiving the attitude and touch pressure values or higher refresh rate of the attitude, the attitude and the touch pressure values are came from a touch sensitive processing apparatus coupled to the touch screen, the touch sensitive processing apparatus is configured to receive electrical signals emitted from eraser electrodes of the electronic board eraser via touch electrodes of the touch screen and to calculate the attitude and the touch pressure values according to the electrical signals and relative positions corresponding to the eraser electrodes.

In one embodiment, in order to support electronic board eraser which is capable of transmitting information via channel other than the touch screen, the method further comprising: receiving the touch pressure values from the electronic board eraser; receiving, from a touch sensitive processing apparatus, touching or approximating events corresponding to eraser electrodes of the electronic board eraser with regard to the touch screen; and calculating the attitude according to the touching or approximating events and relative positions corresponding to the eraser electrodes of the electronic board eraser.

In one embodiment, in order to let the user sets the direction of the erasing area via controlling the attitude of the electronic board eraser, the deciding step further comprises: setting a shape of the erasing area as a pointing shape if it is determined that only one corner of the wiping surface contacts the touch screen, wherein the shape and direction of the pointing shape are corresponding to the attitude.

In one embodiment, in order to let the user sets the erasing area via controlling the attitude of the electronic board eraser, a shape of the erasing area includes an indicating angle for indicating a direction of the erasing area, which is corresponding to an angle between the wiping surface and the touch screen, wherein the angle between the wiping surface and the touch screen is getting larger, the smaller the indicating angle.

In one embodiment, in order to let the user sets the erasing area via controlling the attitude of the electronic board eraser, a size of the erasing area is decided according to one or any combination of following parameters: an angle between the wiping surface and the touch screen; the touch pressure value corresponding to the corner contacts the touch screen; and an average pressure value of an edge of the wiping surface contacts the touch screen.

In one embodiment, in order to let the user sets the erasing probability via controlling the touch pressure, erasing probability inside the erasing area is identical, which is corresponding to the touch pressure value corresponding to the corner contacts the touch screen.

In one embodiment, in order to emulate traditional board eraser, erasing probabilities inside the erasing area are not identical, wherein the erasing probabilities are varied according to the direction of the pointing shape, as described in the embodiments as shown in FIG. 14A or 14B.

In one embodiment, in order to reflect the shape around the corner which contacts the touch screen is asymmetric, the pointing shape is asymmetric, wherein the pointing shape is set according to two angles between two edges, adjacent to the corner, and the touch screen, respectively.

In one embodiment, in order to let the electronic board eraser in use with a curve screen, the attitude is corresponding to a local plane where the corner contacts the touch screen if the touch screen is a curve screen.

According to an embodiment of the present invention, a system for setting erasing area is provided. The system, comprising: a touch sensitive processing apparatus coupled to a touch screen; and a host, coupled to the touch sensitive processing apparatus, configured to execute a program stored in a non-volatile memory for implementing following steps: receiving an attitude of an electronic board eraser relative to the touch screen and touch pressure values; determining whether at least one corner of an wiping surface of the electronic board eraser contacts the touch screen; and deciding properties of an erasing area if it is determined that at least one corner of the wiping surface of the electronic board eraser contacts the touch screen.

In one embodiment, in order to more quickly for receiving the attitude and touch pressure values or higher refresh rate of the attitude, the attitude and the touch pressure values are came from the touch sensitive processing apparatus, which is configured to receive electrical signals emitted from eraser electrodes of the electronic board eraser via touch electrodes of the touch screen and to calculate the attitude and the touch pressure values according to the electrical signals and relative positions corresponding to the eraser electrodes.

In one embodiment, in order to support electronic board eraser which is capable of transmitting information via channel other than the touch screen, the system further comprises: a signal receiver for connecting to the electronic board eraser, the signal receiver is configured to receive the touch pressure values from a signal transmitter of the electronic board eraser, wherein the host, coupled to the signal receiver, is further configured to execute a program stored in a non-volatile memory for implementing following steps: receiving, from the touch sensitive processing apparatus, touching or approximating events corresponding to eraser electrodes of the electronic board eraser with regard to the touch screen; and calculating the attitude according to the touching or approximating events and relative positions corresponding to the eraser electrodes of the electronic board eraser.

In one embodiment, in order to let the user sets the direction of the erasing area via controlling the attitude of the electronic board eraser, the deciding step further comprises: setting a shape of the erasing area as a pointing shape if it is determined that only one corner of the wiping surface contacts the touch screen, wherein the shape and direction of the pointing shape are corresponding to the attitude.

In one embodiment, in order to let the user sets the erasing area via controlling the attitude of the electronic board eraser, a shape of the erasing area includes an indicating angle for indicating a direction of the erasing area, which is corresponding to an angle between the wiping surface and the touch screen, wherein the angle between the wiping surface and the touch screen is getting larger, the smaller the indicating angle.

In one embodiment, in order to let the user sets the erasing area via controlling the attitude of the electronic board eraser, a size of the erasing area is decided according to one or any combination of following parameters: an angle between the wiping surface and the touch screen; the touch pressure value corresponding to the corner contacts the touch screen; and an average pressure value of an edge of the wiping surface contacts the touch screen.

In one embodiment, in order to let the user sets the erasing probability via controlling the touch pressure, erasing probability inside the erasing area is identical, which is corresponding to the touch pressure value corresponding to the corner contacts the touch screen.

In one embodiment, in order to emulate traditional board eraser, erasing probabilities inside the erasing area are not identical, wherein the erasing probabilities are varied according to the direction of the pointing shape.

In one embodiment, in order to reflect the shape around the corner which contacts the touch screen is asymmetric, the pointing shape is asymmetric, wherein the pointing shape is set according to two angles between two edges, adjacent to the corner, and the touch screen, as described in the embodiments shown in FIG. 14A or 14B.

In one embodiment, in order to let the electronic board eraser in use with a curve screen, the attitude is corresponding to a local plane where the corner contacts the touch screen if the touch screen is a curve screen.

In one embodiment, the system further comprises the touch screen and the electronic board eraser.

### BRIEF DESCRIPTION OF THE DRAWINGS

The present invention can be more fully understood by reading the following detailed description of the preferred embodiments, with reference made to the accompanying drawings, wherein:

FIG. 1 shows a schematic diagram of an electronic system 100 according to an embodiment of the present invention;

FIG. 2 shows a block diagram of a touch sensitive processing apparatus 130 according to an embodiment of the present invention;

FIG. 3A shows a top view of an electronic board eraser 115 according to an embodiment of the present invention;

FIG. 3B shows a side view of an electronic board eraser 115 according to an embodiment of the present invention;

FIG. 3C shows a bottom view of an electronic board eraser 115 according to an embodiment of the present invention;

FIG. 3D shows a bottom view of an electronic board eraser 115 according to an embodiment of the present invention;

FIG. 3E shows a bottom view of an electronic board eraser 115 according to an embodiment of the present invention;

FIG. 3F shows a bottom view of an electronic board eraser 115 according to an embodiment of the present invention;

FIG. 4 shows a block diagram of an electronic board eraser according to an embodiment of the present invention;

FIG. 5A shows an operation timing diagram of an electronic system 100 according to an embodiment of the present invention;

FIG. 5B shows a variation of the embodiment shown in FIG. 5A;

FIG. 5C shows a variation of the embodiments of FIGS. 5A and 5B;

FIGS. 6A-G show operation timing diagrams of the stylus and eraser detection period 520 according to embodiments of the invention;

FIG. 7 shows a schematic flowchart of an electronic board eraser detection method according to an embodiment of the present invention; and

FIG. 8 shows a controlling method for an electronic board eraser according to an embodiment of the present invention.

FIG. 9 shows a diagram of two projection areas corresponding to an electronic board eraser according to an embodiment of the present invention on a touch screen.

FIG. 10 shows a diagram of attitude and axial direction of an electronic board eraser according to an embodiment of the present invention.

FIG. 11A˜C shows diagrams of side views and corresponding erasing areas of an electronic board eraser according to embodiments of the present invention.

FIG. 12 shows a diagram of shapes of erasing areas according to an embodiment of the present invention.

FIG. 13 shows a diagram of symmetric and asymmetric shapes of erasing areas according to embodiments of the present invention.

FIGS. 14A˜C show diagrams of erasing probability variations inside erasing areas according to embodiments of the present invention.

FIG. 15 shows a flowchart of a method for setting an eraser area according to an embodiment of the present invention.

### DETAILED DESCRIPTION OF THE PREFERRED EMBODIMENTS

Some embodiments of the present invention are described in detail below. However, in addition to the descriptions given below, the present invention can be applicable to other embodiments, and the scope of the present invention is not limited by such, rather by the scope of the claims. Moreover, for better understanding and clarity of the description, some components in the drawings may not necessary be drawn to scale, in which some may be exaggerated relative to others, and irrelevant parts are omitted.

If any terms in this application conflict with terms used in any application(s) from which this application claims priority, or terms incorporated by reference into this application or the application(s) from which this application claims priority, a construction based on the terms as used or defined in this application should be applied.

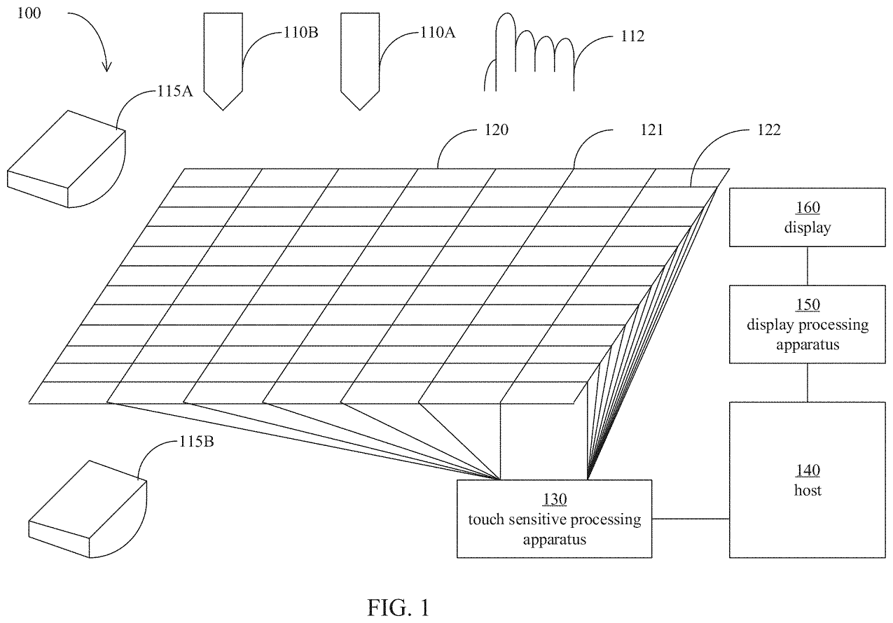

Referring to FIG. 1, it shows a schematic diagram of an electronic system 100 according to an embodiment of the present invention. The electronic system 100 includes a host 140 including a device that controls the overall operation of the electronic system 100, such as the central processing unit, the memory and the interface used to connect the peripheral input/output devices. The interface may include industrial standard interfaces, such as PCI, PCI-E, SATA, ATA, USB, UART, etc., or a proprietary interface. The host 140 connects to a display processing apparatus 150 via the interface, which is used to connect to a display 160 and to process the display contents of the display 160. The host 140 also connects to a touch sensitive processing apparatus 130 via the interface, which is used to connect a transparent touch panel 120 formed by multiple electrodes and to use the touch panel 120 with the multiple electrodes to detect approaching or touching object(s), such as external conductive object (such as hand 112), styluses 110A and 110B, electronic erasers (or electronic board erasers, thereinafter electronic board erasers) 115A and 115B, and so forth. The touch panel 120 includes multiple first electrodes 121 being parallel to a first axis and multiple second electrodes 122 being parallel to a second axis. The touch panel 120 may be set directly on or above the display 160, or the touch panel 120 can be integrated with the display 160 to become an embedded touch panel. The present invention does not limit the combination form of the touch panel 120 and the display 160. In one embodiment, the term touch screen 120 is also used to refer to a combination of touch panel 120 and a display 160.

A central processing unit (CPU) of the host 140 is able to execute instructions and data stored in a non-volatile memory for running an operating system and application programs. The host 140 and the display processing apparatus 150 can singularly or jointly control display of the display 160 or the touch screen 120 according to instructions given by the operating system and the application programs. In this invention, it is collectively called that the host 140 controls the display. When some application programs are executed by the host 140, a drawing area would be shown on the touch screen 120. In response to inputs of the stylus 110A or the stylus 110B on the drawing area, corresponding handwriting tracks of the stylus 110A or the stylus 110B would be appeared on the drawing area. The display content corresponding to the handwriting tracks would be changed according to the inputs of the stylus 110A or the stylus 110B.

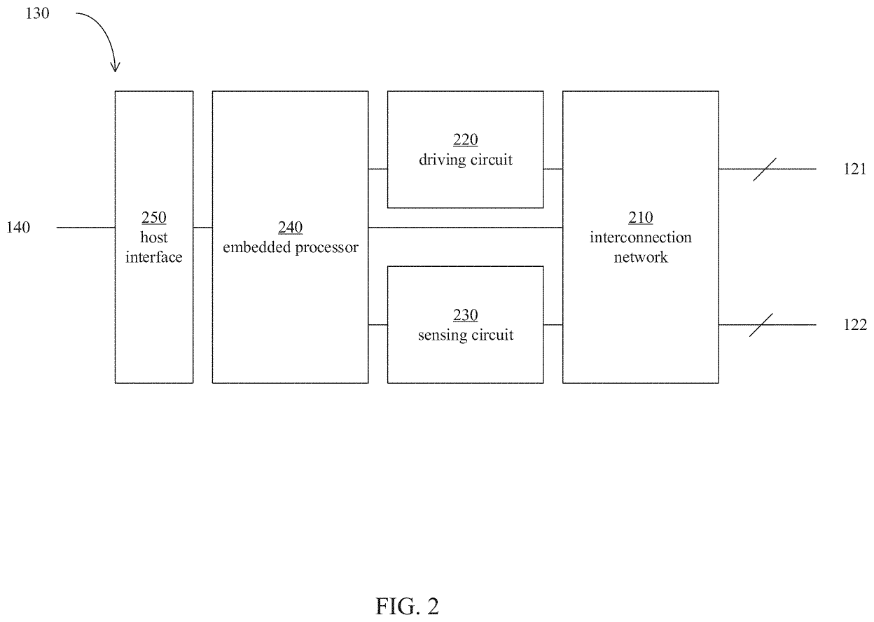

Referring to FIG. 2, it shows a block diagram of a touch sensitive processing apparatus 130 according to an embodiment of the present invention. The touch sensitive processing apparatus 130 includes an embedded processor 240, which is used for connecting and controlling an interconnection network 210, a driving circuit 220, a sensing circuit 230, and a host interface 250. The driving circuit 220 may respectively connect each first electrode 121 and each second electrode 122 via the interconnection network 210 to use these electrodes to emit a driving signal. The sensing circuit 230 may respectively connect each first electrode 121 and each second electrode 122 via the interconnection network 210 to use these electrodes to sense signal(s). The embedded processor 240 can communicate with the host 140 through the host interface 250. The embedded processor 240 may perform a program module stored in non-volatile memory to detect the abovementioned approximate object(s) and event(s).

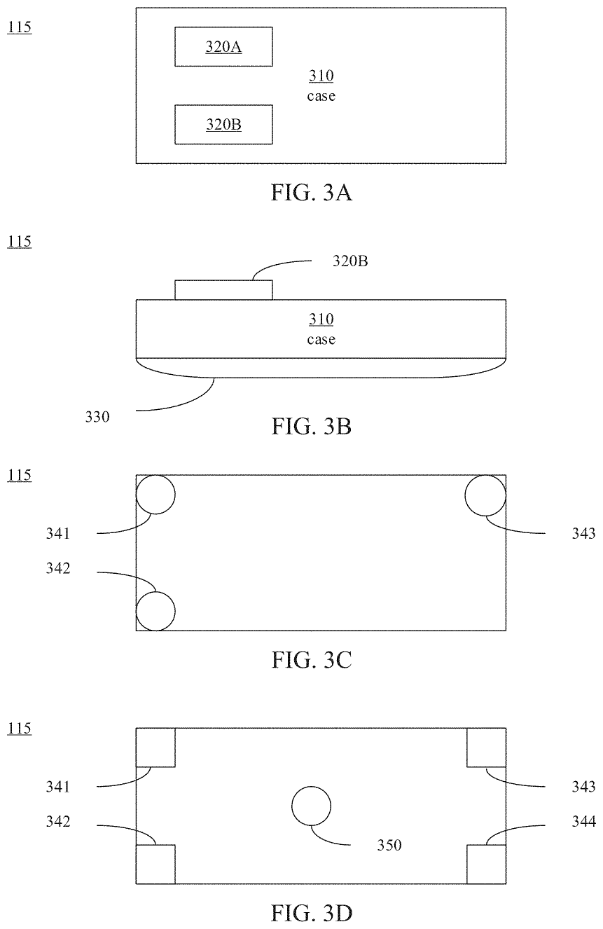

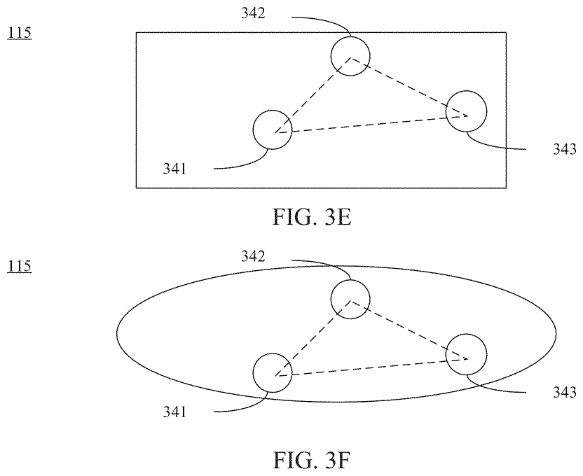

Referring to FIG. 3A, it shows a top view of an electronic board eraser 115 according to an embodiment of the present invention. The eraser 115 can be a cuboid including a housing (or case, thereinafter case) 310 for user's holding and includes a wired/wireless charging or replaceable power supply module and circuit. The top or side of the case 310 may include more than one input device 320, such as a first button 320A and a second button 320B. One of the buttons or switches can be used to startup and shutdown electronic parts inside the electronic board eraser 115. In addition to the traditional mechanical buttons, the input device 320 may be rollers, multi-stage switches, touch buttons, accelerometers, gyroscopes, moving sensors and other devices. The case 310 may also include an output device, such as a lamp, vibrator, and sounder, indicating the amount of electricity or the state of its use.

Referring to FIG. 3B, it shows a side view of an electronic board eraser 115 according to an embodiment of the present invention. The bottom of the case 310 includes an elastic erasing (or wiping, thereinafter wiping) surface 330. In addition to being used to touch the touch panel 120, the wiping surface 330 can be used to erase handwritings written on traditional whiteboard by marker. The case 310, the input device 320 and the wiping surface 330 may be constituted by waterproof material, their connection parts may also be waterproof, to facilitate the user to clean the electronic board eraser 115.

Referring to FIG. 3C, it shows a bottom view of an electronic board eraser 115 according to an embodiment of the present invention. In this embodiment, the wiping surface 330 includes a first eraser electrode 341, a second eraser electrode 342, and a third eraser electrode 343. They are respectively in three corners of the wiping surface 330. The wiping surfaces of these three corners may be elastic conductive material, used as eraser electrodes.

Referring to FIG. 3D, it shows a bottom view of an electronic board eraser 115 according to an embodiment of the present invention. In this embodiment, the wiping surface 330 includes a first eraser electrode 341, a second eraser electrode 342, a third eraser electrode 343, and a fourth electrode 344. They are respectively in four corners of the wiping surface 330. The wiping surfaces of these four corners may be elastic conductive material, used as eraser electrodes.

In one embodiment, these eraser electrodes 341-344 may include force sensors or a part of force sensors. These force sensors, such as force sensing resistors, force sensing capacitors, and other passive components, sense the pressure. Or, these force sensors sense the pressure by active components.

The passive force sensor can refer to the applicant's U.S. patent application, US2015/0153845, and its priority document. This application used a stylus as an example, but it can be applicable to the electronic board eraser 115 of the present invention. For example, FIGS. 2-5 of the application, which use at least two signal sources with different frequencies to respectively output a signal with a first frequency and a signal with a second frequency to a first component with variable impedance and a second component with fixed impedance. The first component is subject to the pressure of the stylus tip (such as the eraser electrodes 341-344 in the present invention) to change its impedance, and the tip or the eraser electrodes 341-344 emits/emit electrical signal(s) to the touch panel 120. A relationship between the amplitude of the first frequency signal in the electrical signal and the amplitude of the second frequency signal in the electrical signal can represent the pressure received by the tip or the eraser electrodes 341-344.

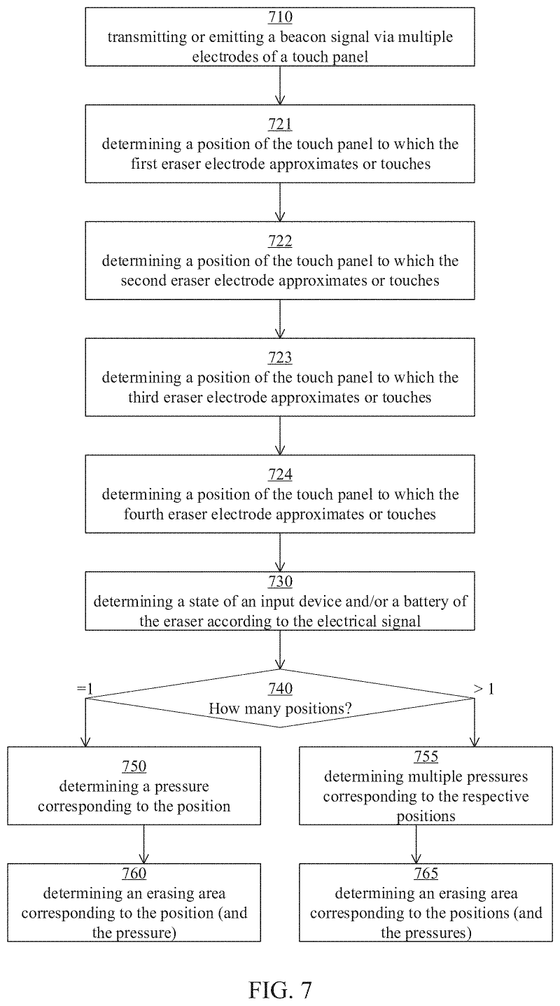

FIGS. 7A-7D of the application, are the use of a single frequency signal source, which respectively outputs a signal with a first frequency signal and a signal with a second frequency signal to a first component with variable impedance and a second component with fixed impedance. The first component is subject to the pressure of the stylus tip (such as the eraser electrodes 341-344 in the present invention) to change its impedance. The electronic board eraser 115 can calculate the current values of the outputs of the first component and the second component respectively, which indicates the pressure value(s) received by the tip or eraser electrodes 341-344.

As for the active force sensor, it can refer to the example of Republic of China (Taiwan) patent publication No. 201339904. This case also takes the stylus as an example, but it can be applicable to the electronic board eraser 115 of the present invention. It only needs to change the stylus tip and the signal transmitter to the eraser electrodes 341-344.

Compared with the shape of the eraser electrode in FIG. 3C, the shape of the eraser electrode in FIG. 3D is different. The present invention does not limit the shape of the eraser electrodes 341-344. In FIG. 3D, the electronic board eraser 115 further includes a sensing electrode 350. The sensing electrode 350 may locate on the surface of the wiping surface 330. Although the sensing electrode 350 shown in FIG. 3D is positioned in the middle of the wiping surface 330, the present invention does not limit the position of the sensing electrode 350. The sensing electrode 350 can be used to receive a beacon signal from the touch panel 120. When the beacon signal is strong, the sensing electrode 350 does not need to be located on the surface of the wiping surface 330, it can be set in the case 310 and can sense the beacon signal.

Referring to FIG. 3E, it shows a bottom view of an electronic board eraser 115 according to an embodiment of the present invention. In this embodiment, the wiping surface 330 includes a first eraser electrode 341, a second eraser electrode 342, and a third eraser electrode 343. These three eraser electrodes 341-343 are not in the corners of the wiping surface 330 but form a triangle on the wiping surface 330. In order to identify the direction of the electron board eraser 115, each side of the triangle formed by the three eraser electrodes 341-343 is unequal length. Accordingly, the touch sensitive processing apparatus 130 can detect the positions of the eraser electrodes 341-343 and calculate the area that the wiping surface 330 of the electronic board eraser 115 projects onto the surface of the touch panel 120.

Referring to FIG. 3F, it shows a bottom view of an electronic board eraser 115 according to an embodiment of the present invention. In this embodiment, the wiping surface 330 is an ellipse. In other words, the electronic board eraser 115 can be an elliptical cube to facilitate user grip. The present invention does not limit the shape of the electronic board eraser 115 and its wiping surface 330 if it is convenient to use.

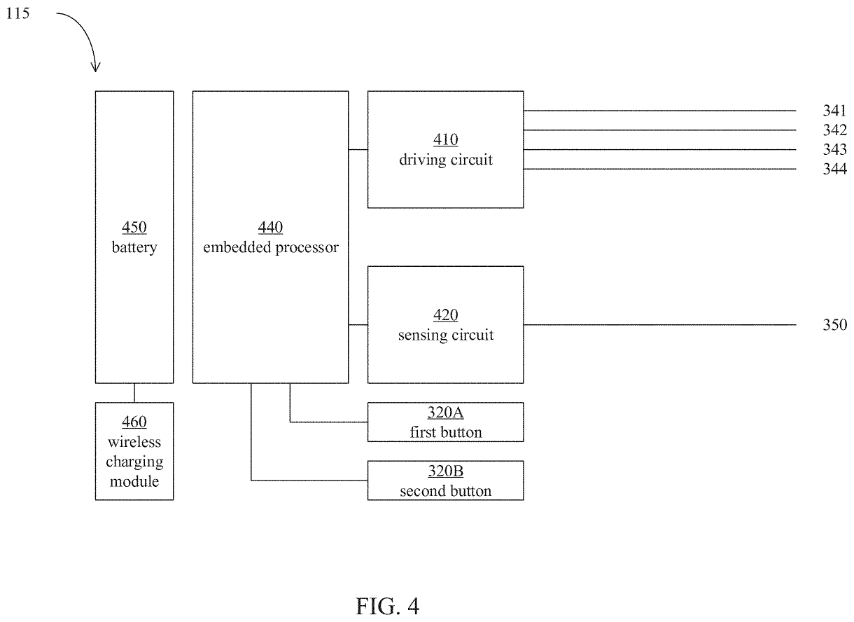

Referring to FIG. 4, it shows a block diagram of an electronic board eraser according to an embodiment of the present invention. The electronic board eraser 115 may include a driving circuit 410, a sensing circuit 420, an embedded processor 440, a battery 450, and a wireless charging module 460 coupled to the battery 450. The battery 450 is used to supply electric power to internal electronic components of the electronic board eraser 115. The driving circuit 410 connects to the eraser electrodes 341-344 respectively to emit electrical signals to the touch panel 120. The sensing circuit 420 connects to the sensing electrode 350 to detect beacon signals. The embedded processor 440 connects to the driving circuit 410, the sensing circuit 420 and the abovementioned input device(s) and the output device(s), such as the first button 320A and the second button 320B. The embedded processor 440 can perform a program module stored in non-volatile memory to enable the touch sensitive processing apparatus 130 to detect the action of the electronic board eraser 115. The wireless charging module 460 can be used to receive wireless charging signal to charge the battery 450. The wireless charging signal may come from the touch panel 120 or particular wireless charging module.

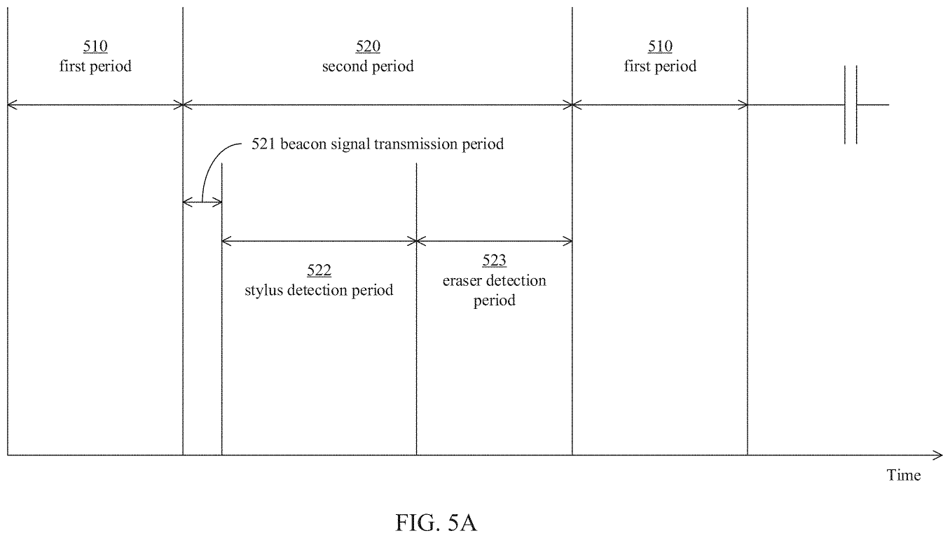

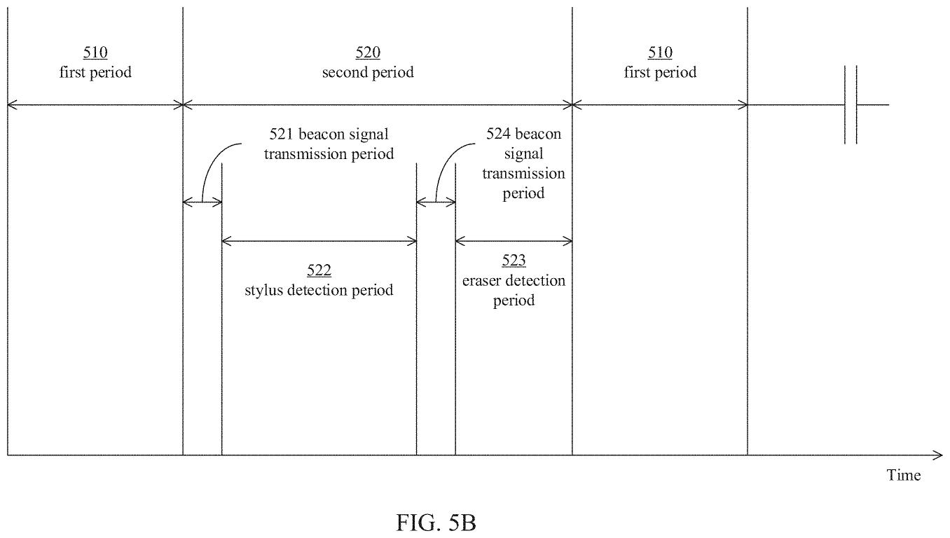

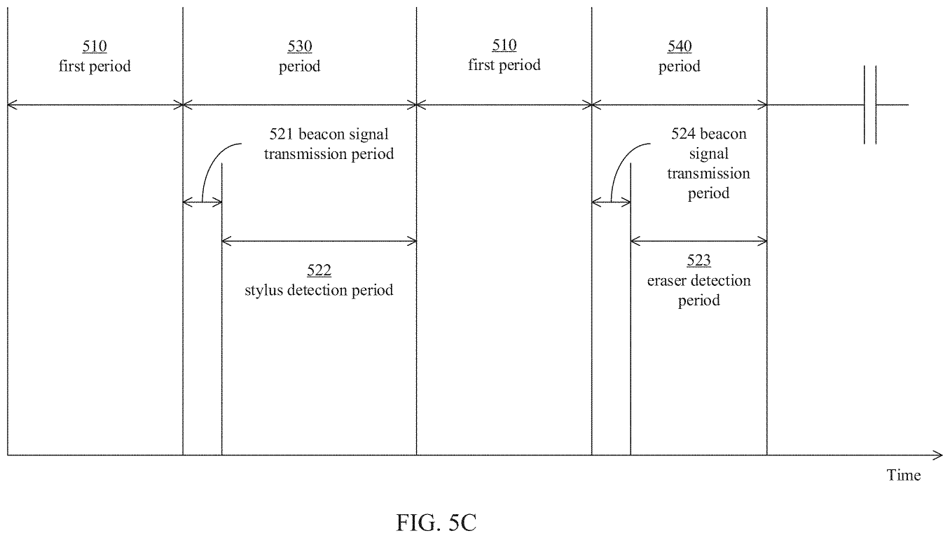

Referring to FIG. 5A, it shows an operation timing diagram of an electronic system 100 according to an embodiment of the present invention. In FIG. 5A, it includes a first period 510 for external object detection and a second period 520 for the stylus and eraser detection. The present invention does not limit the ratio of the first period 510 to the second period 520 to 1:1, nor the first period 510 and the second period 520 having to be interlacing. When the touch sensitive processing apparatus 130 judges only external object approximates the touch panel 120, the proportion of the second period 520 can be reduced. When the touch sensitive processing apparatus 130 judges only the stylus and the eraser approximate the touch panel 120, the proportion of the first period of 510 can be reduced. In the second period 520, it includes a beacon signal transmission period 521, a stylus detection period 522, and an eraser detection period 523. In the present invention, the sequence of the stylus detection period 522 and the eraser detection period 523 is not limited, but the stylus detection period 522 and the eraser detection period 523 shall be after the beacon signal transmission period 521.

Referring to FIG. 5B, it shows a variation of the embodiment shown in FIG. 5A. In FIG. 5B, the second period 520 contains another beacon signal transmission period 524. After the period 521 in which the beacon signal is emitted, the stylus 110 and the touch sensitive processing apparatus 130 perform procedure for detecting the stylus 110 during the period 522. After the period 524 in which another beacon signal is emitted, the electronic board eraser 115 and the touch sensitive processing apparatus 130 perform procedure for detecting the eraser during the period 523. The stylus detection period 522 and the eraser detection period 523 do not need to be immediately following the period 521 and the period 524 respectively, blank (turnaround) periods for the stylus 110 and the eraser 115 to perform receiving processing and preparation may be respectively included between them.

Referring to FIG. 5C, it shows a variation of the embodiments of FIGS. 5A and 5B. In FIG. 5C, the stylus and the eraser are detected in the discontinuous period 530 and 540 respectively. This is owing to the use of habits, when the stylus is in use, the eraser is usually idle; when the eraser is in use, the stylus is usually absent. Consequently, when the touch sensitive processing apparatus 130 determines that only the stylus approximates the touch panel, the proportion of the periods 510 and 540 can be reduced. When the touch sensitive processing apparatus 130 determines that only the eraser approximates the touch panel, the proportion of the periods 510 and 530 can be reduced.

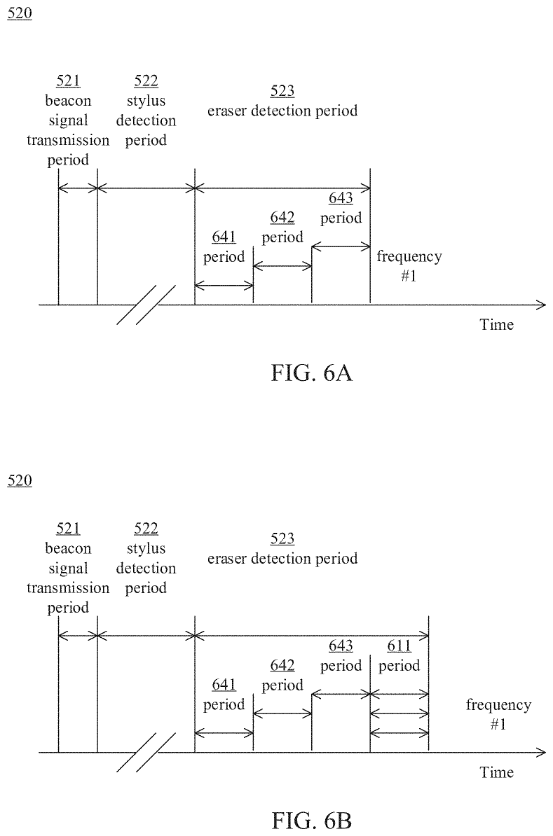

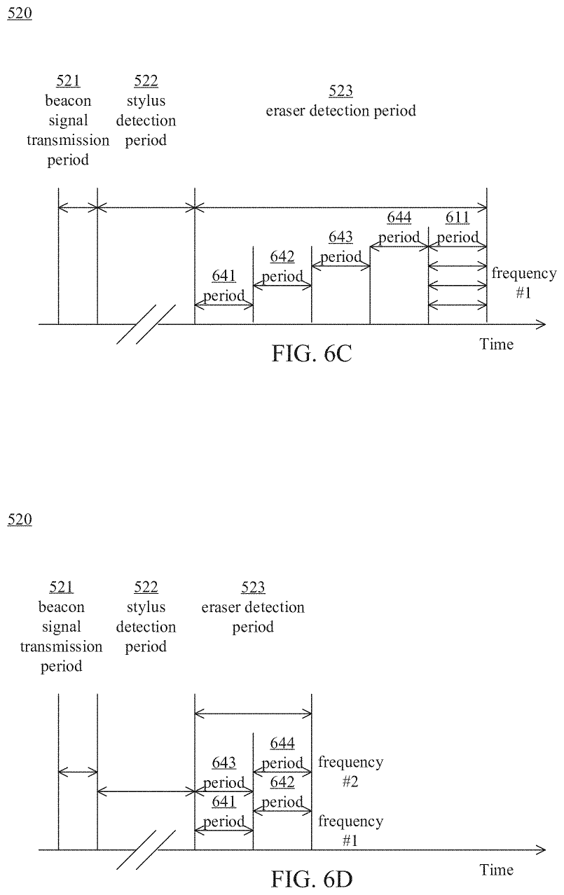

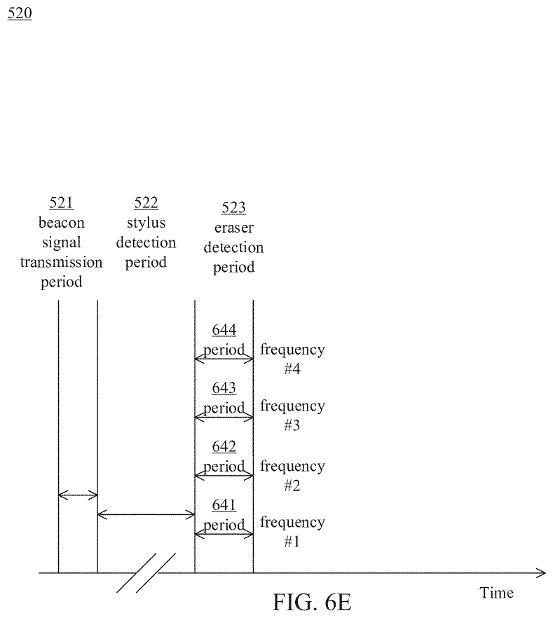

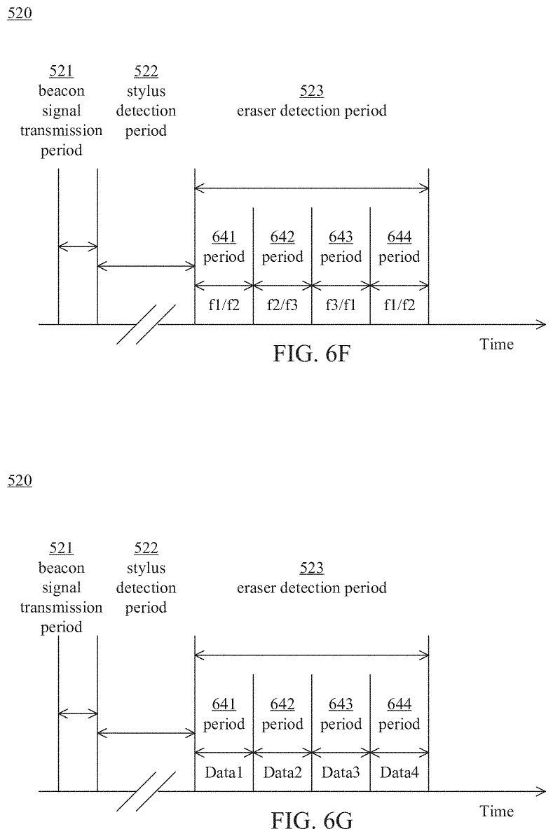

Referring to FIGS. 6A-6G, they show operation timing diagrams of the stylus and eraser detection period 520 according to embodiments of the invention. They can be applicable to the eraser 115 in the embodiments of FIGS. 3A-F and FIG. 4. Although these embodiments are based on the stylus and eraser detection period 520 in FIG. 5A, a person having ordinary skill in the art can appreciate that if the stylus detection period 522 is omitted and the beacon signal transmission period 521 is changed to the beacon signal transmission time 524, it can be applicable to the embodiments of FIGS. 5B and 5C.

In the embodiment of FIG. 6A, in the period 521, the sensing circuit 420 can detect beacon signals emitted by the touch panel 120 through the sensing electrode 350. Then, in the embodiments of FIGS. 3C, 3E, and 3F, the embedded processor 440 allows the driving circuit 410 to transmit the same first frequency signal to the touch panel 120 through the three eraser electrodes 341-343 at three periods 641-643, respectively. After the beacon signal is issued, the touch sensitive processing apparatus 130 can detect the electrical signal through each of the electrodes 121 and 122 on the touch panel 120 to find out the positions of the three eraser electrodes 341-343 corresponding to the touch panel 120.

Referring to FIG. 6B, it shows a variation of the embodiment of FIG. 6A. It can be applicable to the embodiments of FIGS. 3C, 3E, and 3F as well. The embedded processor 440 can enable the driving circuit 410 to transmit the status messages of the input device 310 and/or the battery 450 via at least one eraser electrode in a period 611 after the three periods 641-643. For example, the same use of the first frequency to transmit the message, but the present invention does not limit the use of the same signal modulation method to transmit the message. In one variation, the driving circuit 410 in the period 611 simultaneously transmits the message via the three eraser electrodes 341-343.

Referring to FIG. 6C, it shows a variation of the embodiment of FIG. 6B. It is applicable to the embodiment of FIG. 3D. The difference from the embodiment of FIG. 6B is that the embedded processor 440 uses four periods 641-644, respectively, to enable the driving circuit 410 to emit a signal with the same first frequency via the eraser electrodes 341-344. Since the user does not necessarily make the wiping surface 330 of the eraser 115 fully touch on the touch panel 120 for use, and the user may touch the touch panel 120 with only one corner or side of the eraser 115, making only one or two of the four eraser electrodes 341-344 approximate the touch panel 120, the touch sensitive processing apparatus 130 may not receive electrical signals from two or three eraser electrodes. Therefore, during the period 611, the driving circuit 410 transmits the message through the four eraser electrodes 341-344 at the same time to ensure that at least one eraser electrode sends the message to be received.

Referring to FIG. 6D, it utilizes signals with two frequencies to shorten the length of the eraser detection period 523. The driving circuit 410 can simultaneously output signals with two frequencies to two eraser electrodes, such as outputting a first frequency signal to the first eraser electrode 341, while outputting a second frequency signal to the third eraser electrode 343. In other words, the first eraser electrode transmission period 641 and the third eraser electrode transmission time 643 can be folded together. Then, it outputs the first frequency signal to the second eraser electrode 342, simultaneously outputting the second frequency signal to the fourth eraser electrode 344. In other words, the second eraser electrode transmission period 642 and the fourth eraser electrode transmission time 644 can be folded together. The present invention does not limit which two eraser electrodes are output simultaneously. The two frequencies may be independent of each other's resonant frequencies. After that period, the message transmission period 611 can also be appended to.

Referring to FIG. 6E, it utilizes signals with four frequencies to shorten the length of the eraser detection period of 523. The driving circuit 410 can simultaneously output signals with four frequencies to the four eraser electrodes 341-344, making each eraser electrode transmission periods 641-643 overlap simultaneously. The four frequencies can be independent of the resonant frequencies of other frequencies. After that, the message transmission period 611 can also be appended to. When this case applies to the embodiments of FIGS. 3C, 3E, and 3F, four frequencies can be reduced to three frequencies.

Referring to FIG. 6F, in addition to emitting the electrical signals that allow the touch sensitive processing apparatus 130 to detect positions, each of the eraser electrodes 341-344 may emit an electrical signal representing received pressure. As previously mentioned, the relevant embodiments of FIGS. 2-5 of US2015/0153845, or the changes in the technical solutions shown in the example of No. 201339904 may be used. At each of the eraser electrode transmission periods 641-644, each of the eraser electrodes 341-344 in time-sharing manner emits an electrical signal including two frequencies, which indicates the pressure value received by the respective eraser electrode.

Referring to FIG. 6G, the same as those shown in FIG. 6F, each of the eraser electrodes 341-344 emits an electrical signal representing the pressure received by itself. As previously mentioned, the variations of the technical solutions shown in the relevant embodiments of FIGS. 7A-7B of US2015/0153845 can be used. During each of the eraser electrode transmission periods 641-644, each of the eraser electrodes 341-344 in time-sharing manner emits a modulated electrical signal, which indicates the pressure value received by the respective eraser electrode.

Referring to FIG. 7, it shows a schematic flowchart of an eraser detection method according to an embodiment of the present invention. These steps can be applicable to the touch sensitive processing apparatus 130 shown in FIG. 2.

In step 710: transmitting or emitting a beacon signal via multiple electrodes of a touch panel 120. The beacon signal may be the beacon signal emitted in the period 521 or 524. The driving circuit 220 may be enabled to transmit the beacon signal via all the first electrodes 121 or via all the second electrodes 122. Or, the driving circuit 220 may be enabled to transmit the beacon signal via all the first electrodes 121 and all the second electrodes 122.

In step 721: waiting for a predetermined period after step 710, detecting electrical signal transmitted from a first eraser electrode 341 of an eraser 115 via the multiple electrodes 121 and 122 of the touch panel 120 and determining a position of the touch panel 120 to which the first eraser electrode 341 approximates or touches.

In step 722: waiting for a predetermined period after step 710, detecting electrical signal transmitted from a second eraser electrode 342 of the eraser 115 via the multiple electrodes 121 and 122 of the touch panel 120 and determining a position of the touch panel 120 to which the second eraser electrode 342 approximates or touches.

In step 723: waiting for a predetermined period after step 710, detecting electrical signal transmitted from a third eraser electrode 343 of the eraser 115 via the multiple electrodes 121 and 122 of the touch panel 120 and determining a position of the touch panel 120 to which the third eraser electrode 343 approximates or touches.

In optional step 724: waiting for a predetermined period after step 710, detecting electrical signal transmitted from a fourth eraser electrode 344 of the eraser 115 via the multiple electrodes 121 and 122 of the touch panel 120 and determining a position of the touch panel 120 to which the fourth eraser electrode 344 approximates or touches.

The abovementioned steps 721-724 may be performed in time division manner as those shown in FIGS. 6A-6C and 6F-6G or in the same time period as those shown in FIGS. 6D-6E.

In optional step 730: waiting for a predetermined period after step 710, detecting electrical signal(s) transmitted from at least one of the eraser electrodes 341-344 via the multiple electrodes 121 and 122 of the touch panel 120 and determining (a state)/states of an input device and/or a battery of the eraser 115 according to the electrical signal(s).

In step 740: determining how many position(s) there is(are) corresponding to those eraser electrode(s). If there is only one position, it means that the user uses only one corner of the eraser 115 to erase the handwriting, then the process goes to step 750/760. If there are two positions, it means that the user uses one side of the eraser 115 to erase the handwriting, then the process goes to step 755/765.

In optional step 750: determining a pressure corresponding to the position. The pressure received by the eraser electrode can be obtained by demodulating the electrical signal. The pressure can also be determined according to the area size of the position.

In optional step 755: determining multiple pressures corresponding to the respective positions. The pressures respectively received by the multiple eraser electrodes can be obtained by demodulating the electrical signals. The corresponding pressures can also be determined separately according to a sum of the area sizes of the positions.

In step 760: determining an erasing area corresponding to the position (and the pressure). If the pressure can be calculated, size of the erasing area can be determined according to the pressure. For example, the pressure gets bigger, the size of the erasing area becomes bigger. The pressure and the area size may be proportional, or they have a non-linear relationship.

In step 765: determining an erasing area corresponding to the positions (and the pressures). If a sum or an average of the pressures can be calculated, size of the erasing area can be determined according to the pressures. For example, the sum or average of the pressures gets bigger, the size of the erasing area becomes bigger. The sum or average of the pressures and the area size may be proportional, or they have a non-linear relationship.

In another embodiment, the pressure and an erasing probability in the erasing area may be proportional or have a non-linear relationship. The so-called erasing probability herein refers to a chance of each pixel in the erasing area is erased. For example, when the erasing probability is 80%, the 80% pixels in the erasing area will be erased and remaining 20% pixels unchanged.

In further another embodiment, the pressure and an erasing change probability in the erasing area may be proportional or have a non-linear relationship. The so-called erasing change probability herein refers to the change rate of each pixel in the erasing area. For example, the red, green, and blue, three-color values, of the pixel are represented as R, G, and B, respectively. When the erasing change probability is 80%, the change rate of the pixel in a certain period is 0.2R, 0.2G, 0.2B. The above changes can simulate the erasing effect of the traditional eraser to the traditional whiteboard.

In certain embodiments of applications, erasers can be used as brushes. The input device 310 on the eraser 115 may be used to switch the eraser's usage modes. When the touch sensitive processing apparatus 130 in step 730 receives the state change of the input device 310, it needs to inform the operating system and application(s) executed by the host 140 to change the input mode of the eraser.

In one embodiment, the embedded processor 440 of the eraser 115 can go into power-saving mode. For example, after the eraser 115 is placed below the touch panel 120 in still for a period and the beacon signal can be received, but if the processor 440 does not receive a start signal from the accelerometer, gyroscope, and moving sensor, the eraser electrode will not emit the electrical signal to conserve electric power.

In another embodiment, the eraser 115 is usually placed near the touch panel 120. Therefore, the eraser 115 may further include a wireless charging module, charging the battery 450 using the beacon signal or charging signal emitted by the touch panel 120.

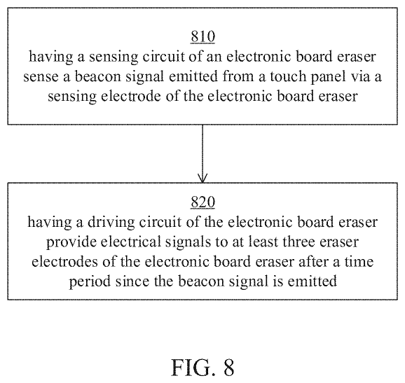

Referring to FIG. 8, it shows a controlling method for an electronic board eraser according to an embodiment of the present invention. The controlling method is applicable to the electronic board eraser 115 and the processor 440 shown in FIG. 4.

In step 810: having a sensing circuit of an electronic board eraser sense a beacon signal emitted from a touch panel via a sensing electrode of the electronic board eraser.

In step 820: having a driving circuit of the electronic board eraser provide electrical signals to at least three eraser electrodes of the electronic board eraser after a time period since the beacon signal is emitted. The electrical signals' modulation method includes one of the following: emitting a same frequency set of electrical signals via the at least three eraser electrodes sequentially in time-sharing manner; emitting status messages via one of or multiple the eraser electrodes simultaneously; emitting different frequency sets of electrical signals via at least two of the eraser electrodes simultaneously; and emitting two different frequency sets of electrical signals via the at least three eraser electrodes sequentially in time-sharing manner.

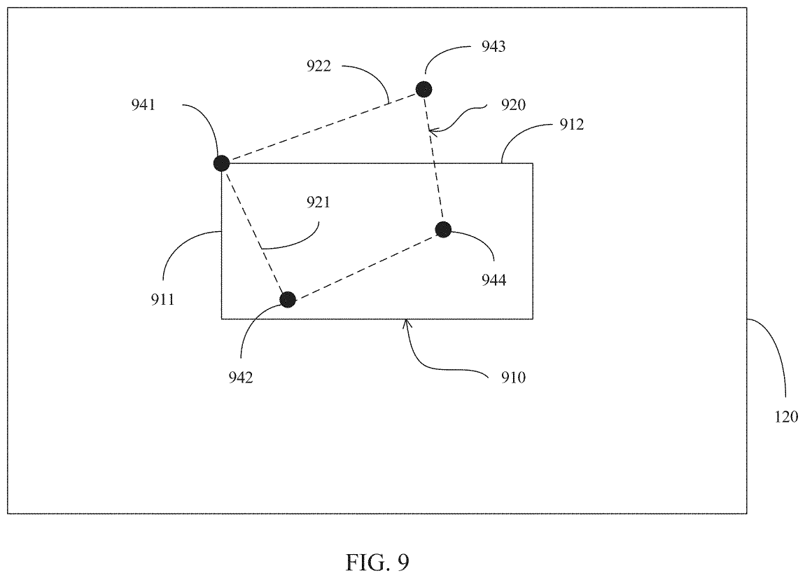

Please refer to FIG. 9, which shows a diagram of two projection areas corresponding to an electronic board eraser according to an embodiment of the present invention on a touch screen 120. In case a shape of a wiping surface of the electronic board eraser is a rectangle, the projection area 910 of the electronic board eraser is also rectangular when the electronic board eraser is flatly placed on the touch screen 120. The rectangle is with two short edges 911 and two long edges 912. The length of the long edge 912 is larger than the length of the short edge 911.

When the left upper corner of the electronic board eraser touches a position of the touch screen 120 and the rest part of the electronic board eraser is clear of the touch screen 120, the corresponding projection area 920 is smaller than the projection area 910. The length of a long edge 922 of the projection area 920 would be shorter than the corresponding long edge 912 of the projection area 910. Similarly, the length of a short edge 921 of the projection area 920 would be shorter than the short edge 911 of the projection area 910. Theoretically, when the upper left corner is still in contact with the touch screen 120, a first angle between the short edge 921 of the electronic board eraser and the touch screen 120 may be calculated by computing a length ratio between the short edge 921 and the short edge 911. Similarly, a second angle between the long edge 922 of the electronic board eraser and the touch screen 120 may be calculated by computing a length ratio between the long edge 922 and the long edge 912.

A premise of the angle calculations is that the upper left corner of the electronic board eraser is still in contact with the touch screen 120. In the embodiments as shown in FIGS. 3C and 3D, the eraser electrode 341 of the electronic board eraser 115 is placed at the upper left corner. When the touch sensitive processing apparatus 130 detects the eraser electrode 341 via the touch screen 120 and detects the eraser electrode 341 is under pressure, it may be determined that the upper left corner where the eraser electrode 341 located is in contact with the touch screen 120.

It is already mentioned that the electronic board eraser can use a passive force sensor to detect pressure against to the eraser electrode. Examples are given in the Applicant's U.S. patent application No. 2015/0,153,845 as well as its priority documents. The eraser electrode 341 transmits electrical signals with two frequencies or two frequency groups, where the signal strength of one of the frequencies or one of the frequency groups is changed according to a variable impedance of the force sensor. If the touch sensitive processing apparatus detects a signal strength ratio between these two frequencies or two frequency groups is changed, it may determine that the force sensor corresponding to the eraser electrode 341 is under pressure. When the touch sensitive processing apparatus receives electrical signal during a time period corresponding to the eraser electrode 341 or receives electrical signal with a specific frequency corresponding to the eraser electrode 341, it may determine that the upper left corner where the force sensor corresponding to the eraser electrode 341 installed is indeed in contact with the touch screen 120, not merely in approximation with the touch screen 120.

Alternatively, the electronic board eraser 115 may be equipped with force sensors at corners of the wiping surface. When the force sensor installed in the upper left corner is pressed, the pressure value can be transmitted to a signal receiver coupled to the touch sensitive processing apparatus 130 or the host 140 via a signal transmitter of the electronic board eraser 115. The signal transmitter and receiver may be wireless transceivers compliant to industrial standards such as Wireless Local Area Network (WLAN), Blue Tooth, ZigBee, etc. When the touch sensitive processing apparatus 130 or the host 140 receives a non-zero pressure value corresponding to the left upper corner from the electronic board eraser 115 and detects electrical signals emitted from the eraser electrode 341, it may determine that the upper left corner where the force sensor corresponding to the eraser electrode 341 installed is indeed in contact with the touch screen 120, not merely in approximation with the touch screen. The present invention does not limit that how the touch sensitive processing apparatus determines whether it is in contact with the touch screen 120 according to electrical signals emitted from the eraser electrode 341. It may need two or more information from two different sources for determining whether a corner of the electronic board eraser 115 is in contact with the touch screen 120.

Furthermore, when the touch sensitive processing apparatus 130 determines that one corner of the electronic board eraser is in contact with the touch screen 120, it may continue determining, in the same way or in other way, whether other corners of the electronic board eraser are in contact with the touch screen 120. If two corners in contact are adjacent, it may determine that an edge of the electronic board eraser 115 is in contact with the touch screen 120. If these two corners in contact are not adjacent, it may determine that a bottom surface or the wiping surface of the electronic board eraser 115 is in contact with the touch screen 120.

When only one corner of the electronic board eraser 115 contacts the touch screen 120, it may further determine two approximating positions corresponding to two corners adjacent to the contacted corner. As described in the embodiments shown in FIGS. 3C and 3D, the touch sensitive processing apparatus 130 determines respectively the approximation positions of the touch screen 120 corresponding to the eraser electrodes 342 and 343 according to the electrical signals emitted from the eraser electrodes 342 and 343. In other words, since these two corners corresponding to the eraser electrodes 342 and 343 float in the air, the force sensors located in these two corners are not pressed.

In the aforementioned embodiment, the signal strength ratio between two frequencies or two frequency groups in the electrical signals emitted from the eraser electrode 342 remains a constant. It may determine that the eraser electrode 342 is not pressed. By a similar way, it may also determine that the eraser electrodes 343 and 344 are not pressed. Alternatively, when force sensors corresponding to these three corners of the electronic board eraser 115 are not pressed, the sensing results can be transmitted to the signal receiver coupled to the touch sensitive processing apparatus 130 or the host 140 via the signal transmitter.

In case that two corners adjacent to the contacted corner are not under pressure, the touch sensitive processing apparatus 130 may calculate respectively the approximation positions of the eraser electrodes 342 and 343 according to the electrical signals emitted from these eraser electrodes 342 and 343. Since the distance between the touch screen 120 and the eraser electrode 344 located at the across corner of the eraser electrode 341 is larger or equals to the distance between the touch screen 120 and the eraser electrode 342 or 343, the touch sensitive processing apparatus may not find the approximation position on the touch screen 120 corresponding to the eraser electrode 344 by weaker electrical signals traveling through a longer distance.

In the embodiment as shown in FIG. 9, the touch sensitive processing apparatus 130 may find four positions 941, 942, 943 and 944 on the touch screen 120 corresponding to the eraser electrodes 341, 342, 343 and 344, respectively, according to the electrical signals emitted from the eraser electrodes 341, 342, 343 and 344. The corner corresponding to the position 941 is under pressure. Thus it is determined that the eraser electrode 341 is in contact with the touch screen 120. The rest three corners corresponding to positions 942, 943 and 944, respectively, are not pressed, it is determined that the eraser electrodes 342, 343 and 344 do not contact the touch screen 120. The short edge 921 is determined by the positions 941 and 942. The long edge 922 is determined by the positions 941 and 943. Since lengths of the short edge 911 and the short edge 921 of the electronic eraser board 115 are already known, a first angle between the short edge 921 and the touch screen 120 can be calculated according to a length ratio between the short edges 921 and 911. Similarly, lengths of the long edge 912 and the long edge 922 of the electronic eraser board 115 are already known, the second angle between the long edge 922 and the touch screen 120 can be calculated according to a length ratio between the long edges 922 and 912.

In case that the touch sensitive processing apparatus 130 could find the four positions 941, 942, 943 and 944, the projection area 920 can be defined according to four lines of these four positions. Although in this present application, the exemplary electronic board eraser 115 has a rectangular wiping surface as shown in FIG. 3C or 3D, the present application does not limit the shape of the wiping surface is rectangular. In other embodiments, project areas defined by eraser electrodes located in the vertexes of the shape of the wiping surface may be a quadrilateral, such as rhombus, parallelogram, trapezoid, or square. The shape of the projection area may be a polygon, such as triangle, pentagon, hexagon, etc. In one embodiment, the project area 920 may be corresponding to a painting area of a display window of drawing application program. The painting area may be viewed as an area of a brush with a background color. For example, if the background color is white, the painting area corresponding to the projection area 920 becomes white.

If projection areas are already known by the touch sensitive processing apparatus 130, an attitude of the electronic eraser board 115 relative to the touch screen 120 can be determined according to a contact position, two adjacent edges' directions and two angles between these two edges and the touch screen 120. In another embodiment, the electronic board eraser 115 may comprise one or more detection device such as gyroscope, accelerometer, angle accelerometer, electronic compass, etc. for detecting an attitude of the electronic board eraser 115 relative to ground. And the host 140 may also set a predetermined attitude or include one or more detection device such as gyroscope, accelerometer, angle accelerometer, electronic compass, etc. for detecting an attitude of the touch screen 120 relative to ground. After the attitude relative to ground is sent to the host 140 by the electronic board eraser 115, the host 140 can calculate an attitude of the electronic board eraser 115 relative to the touch screen 120 according to the attitude of the electronic board eraser 115 relative to ground and the attitude of the touch screen 120 relative to ground.

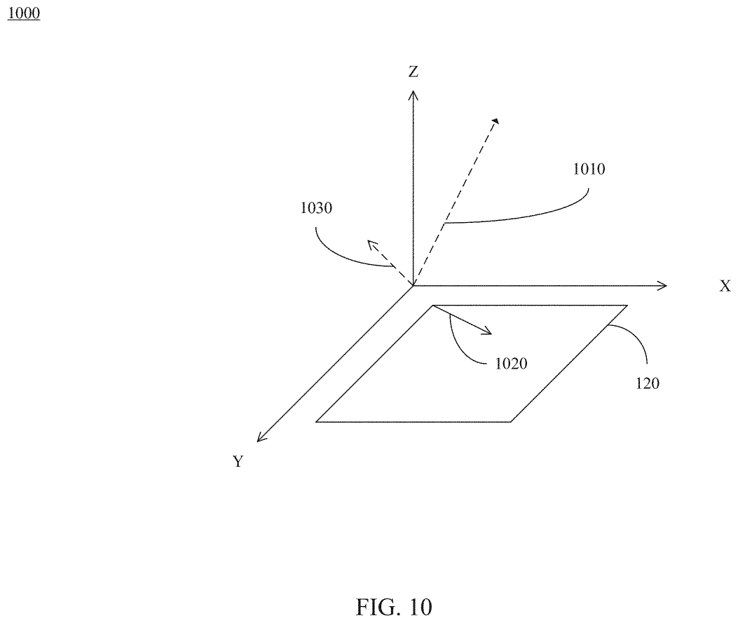

Please refer to FIG. 10, which shows a diagram of an attitude and an axial direction of an electronic board eraser according to an embodiment of the present invention. The XY plane of the 3 dimensional reference coordinate system as shown in FIG. 10 is the surface of the touch screen 120. The Z axis is perpendicular to the XY plane. The origin point of the 3 dimensional reference coordinate system may be placed at the contact position where a corner of the electronic board eraser 115 touches the touch screen 120, for example, the position 941 as shown in FIG. 9. In this embodiment, a first virtual direction or vector of the electronic board eraser 115 may be set up. In one instance, a first virtual vector 1010 may be set according to the eraser electrodes 341 and 344 respectively located at the across corners of the electronic board eraser 115. When the electronic board eraser 115 is flatly placed on the touch screen 120, the first virtual vector 1010 resides in the XY plane. When only the eraser electrode 341 of the electronic board eraser 115 is in contact with the touch screen 120, the first virtual vector 1010 is a three dimensional vector originated from the position 941. The projected vector 1020 of the first virtual vector 1010 on the XY plane is a vector from the position 941 to the position 944.

In order to correctly denote the attitude of the electronic board eraser 115 relative to the touch screen 120, a second virtual vector 1020 is required. The second virtual vector 1030 may not be in parallel to the first virtual vector 1010. In the embodiment as shown in FIG. 10, the second virtual vector 1030 may be a vector originated at the position 941 and extended to the Z axis. The second virtual vector 1030 may be perpendicular to the first virtual vector 1010. When the electronic board eraser 115 is placed on the touch screen 120, the second virtual vector 1030 is perpendicular the XY plane. Person having ordinary skill in the art can understand that the attitude of the electronic board eraser 115 relative to the touch screen 120 can be expressed by the first and the second virtual vectors 1010 and 1030 in the 3 dimensional reference coordinate system as shown in FIG. 10.

The present invention does not limit to use the virtual vectors 1010 and 1030 for denoting the attitude of the electronic board eraser 115, any two non-parallel virtual vectors may be used. In other words, it may use two virtual vectors to express the attitude of the electronic board eraser 115 relative to the touch screen 120. When the touch sensitive processing apparatus 115 is aware of where the eraser electrodes located in the electronic board eraser 115 as well as how the two virtual vectors representing the electronic board eraser 115, person having ordinary skill in the art can understand that the first and the second virtual vectors 1010 and 1030 in the 3 dimensional reference coordinate system can be calculated according to the short edge 921 and the long edge 922 as shown in FIG. 9. Reversely, the short edge 921 and the long edge 922 can be calculated if the first and the second virtual vectors 1010 and 1030 in the 3 dimensional reference coordinate system are known. The two sets of data are interchangeable.

In one embodiment, the size or the shape of the cursor or the erasing area can be determined by one of the two virtual vectors 1010 and 1030 or the projection vector 1020 of the first virtual vector 1010. In another embodiment, the size or the shape of the cursor or the erasing area can be determined by the short edge 921 and the long edge 922 of the projection area 920 on the touch screen 120. Alternatively, the attitude of the electronic board eraser 115 relative to the touch screen 120, which is calculated according to the attitude of the electronic board eraser 115 relative to the ground and the attitude of the touch screen 120 relative to the ground, is used to determine the size or the shape of the cursor or the erasing area.

In one embodiment, if the touch screen 120 is a curve screen, the Z axis of the reference coordinate system as shown in FIG. 10 is a normal axis of the position 941. In other words, the attitude of the electronic board eraser 115 relative to the touch screen 120 is based on the touch position 941 for definitions of the X, Y, Z axes of its reference coordinate system.

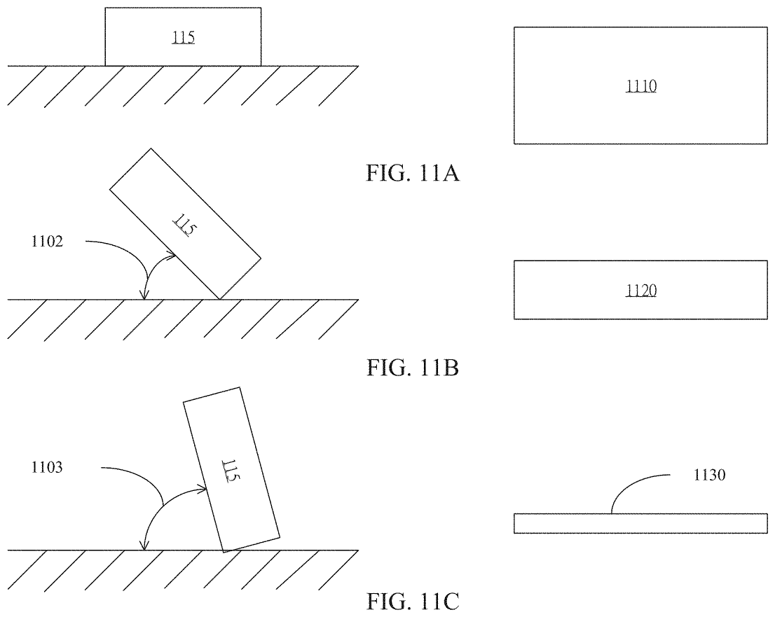

Please refer to FIGS. 11A˜C, which shows diagrams of side views and corresponding erasing areas of an electronic board eraser according to embodiments of the present invention. Left part is a side view of the electronic board eraser 115. Right part is a top view of the corresponding erasing area on the touch screen 120. In the embodiment as shown in FIG. 11A, the electronic board eraser as shown in FIG. 3C or 3D is placed flatly on the touch screen 120, the erasing area 110 may be identical to the projection area of the electronic board eraser 115 on the touch screen 120. The size ratio between the projection area and the erasing area 1110 may be around 1 to 1. However, the erasing area 1110 may be slightly larger than the projection area in all edges to prevent the electronic board eraser 115 being blocking eye sights of a user so as the user can see edges of the erasing area 1110.

In the embodiment as shown in FIG. 11B, when the electronic board eraser 115 contacts the touch screen by an edge, the angle between the wiping surface and the touch screen 120 is denoted as a first angle 1102. For example, when the long edge 912 of the electronic board eraser 115 is in contact with the touch screen 120, the first angle 1102 is the angle between the short edge 921 and the touch screen 120. Reversely, when the short edge 911 of the electronic board eraser 115 is in contact with the touch screen 120, the first angle 1102 is the angle between the long edge 922 and the touch screen 120. Under these circumstances, the size of the corresponding erasing area 1120 is smaller than the erasing area 1110. In one embodiment, the size of the erasing area 1120 is related to the size of the erasing area 1110 and the first angle 1102. For example, the size of the erasing area 1120 is a product of the size of the erasing area 1110 and a function of the first angle 1102. The function may be linear or non-linear.

In the embodiment as shown in FIG. 11C, a second angle 1103 between the electronic board eraser 115 and the touch screen 120 is larger than the first angle 1102. Meanwhile, the size of the erasing area 1130 is smaller than the erasing area 1120. Analogously, the size of the erasing area 1130 is related to the size of the erasing area 1110 and the second angle 1103. For example, the size of the erasing area 1130 is a product of the size of the erasing area 1110 and a function of the second angle 1103. The function may be linear or non-linear. In one embodiment, there is a minimum of the size of the rectangular erasing area. When the angle between the wiping surface and the touch screen 120 is larger than a threshold, the size of the erasing area remains the minimum.

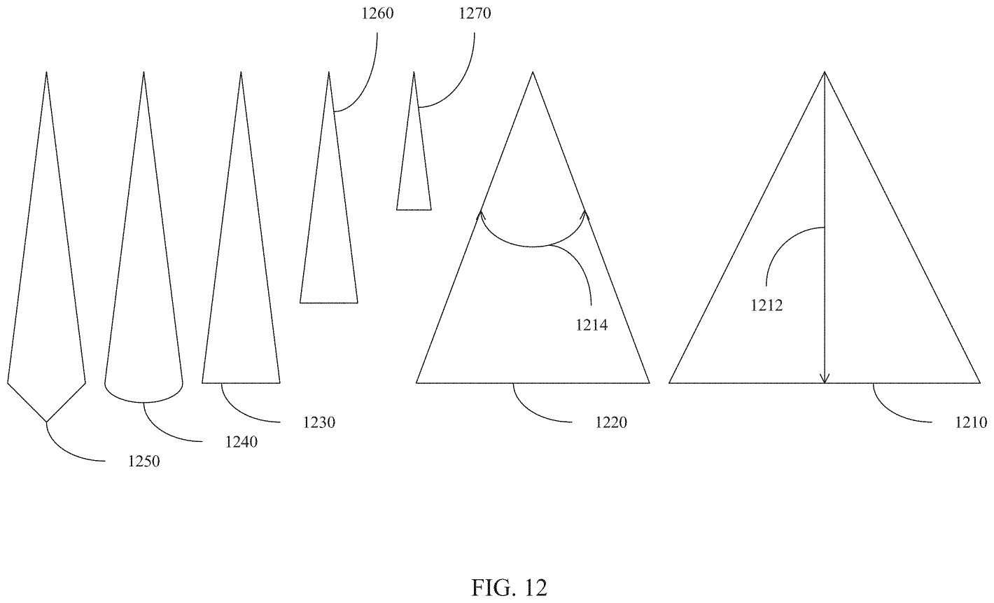

Please refer to FIG. 12, which shows a diagram of shapes of erasing areas according to an embodiment of the present invention. The diagram shows three kinds of symmetric shapes of erasing areas. The shapes of the erasing areas 1210, 1220, 1230, 1260 and 1270 are isosceles triangles. The shape of the erasing area 1240 is a water drop. The shape of the erasing area 1250 is a quadrilateral like an arrowhead. When a corner of the electronic board eraser 115 contacts the touch screen 120, the erasing area may be changed to one of the aforementioned shapes. Please be aware that the shapes as shown in FIG. 12 are exemplary. The present application does not limit the shapes of the erasing area.

In one embodiment, an indicating angle of the erasing area may be corresponding to the position 941. In an example, the indicating angle 1214 of the erasing area is set corresponding to an angle between the short edge 921 and the touch screen 120. In another example, the indicating angle 1214 of the erasing area is set corresponding to an angle between the long edge 922 and the touch screen 120. In an alternative example, the indicating angle 1214 may be set corresponding to a function. The value of the function is corresponding to the angle between the short edge 921 and the touch screen 120 and the angle between the long edge 922 and the touch screen 120.

In one embodiment, a pointing direction of the erasing area may be corresponding to the projection vector 1020 as shown in FIG. 10. The length of the erasing area may be corresponding to the length of the projection vector 1020. For example, if the angle between the wiping surface of the electronic board eraser 115 and the touch screen 120 is getting larger, the length and the size of the erasing area is getting shrinking. The sizes of the erasing areas 1230, 1260 and 1270 are getting smaller, the corresponding angles between the wiping surface and the touch screen are getting larger. The size of the erasing area is set corresponding to the angle between the wiping surface and the touch scree 120. In one embodiment, there is a minimum size of the erasing area. When the angle between the wiping surface and the touch screen 120 is larger than a threshold, the size of the erasing area remains the minimum.

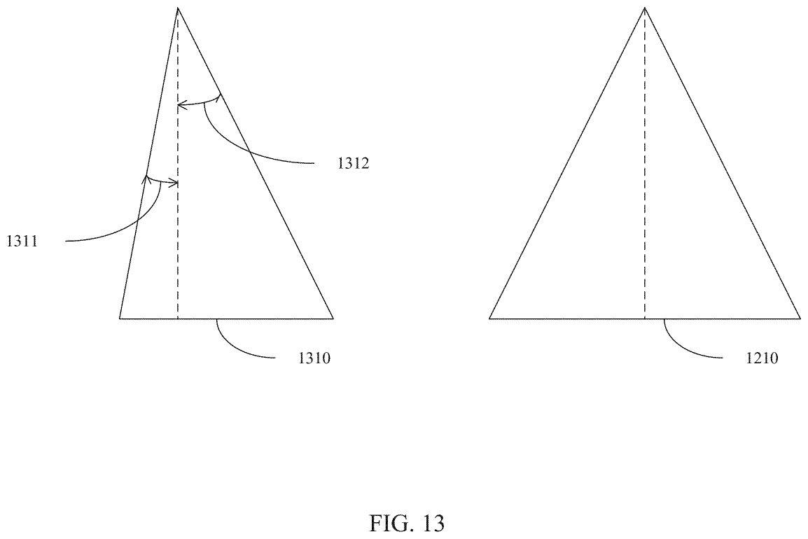

Please refer to FIG. 13, which shows a diagram of symmetric and asymmetric shapes of erasing areas according to embodiments of the present invention. As shown in FIG. 13, in additional to axis symmetric isosceles triangular erasing area 1210, there is an asymmetric triangular erasing area 1310. The top angle of the erasing area 1310 can be split into two angles 1311 and 1312. In one embodiment, these two angles 1311 and 1312 can be set corresponding to the angle between the short edge 921 and the touch screen 120 and the angle between the long edge 922 and the touch screen 120, respectively. Or reversely, these two angles 1312 and 1311 can be corresponding to the angle between the short edge 921 and the touch screen 120 and the angle between the long edge 922 and the touch screen 120, respectively.

In one embodiment, the erasing area may include a first erasing area and a second erasing area adjacent to the first erasing area. The shape and the size of the first erasing area are corresponding to the angle between the short edge 921 and the touch screen 120. The shape and the size of the second erasing area are corresponding to the angle between the long edge 922 and the touch screen 120. In one example, when the angle between the short edge 921 and the touch screen 120 is corresponding to the angle between the long edge 922 and the touch screen 120, the first and the second erasing areas are axis symmetric.

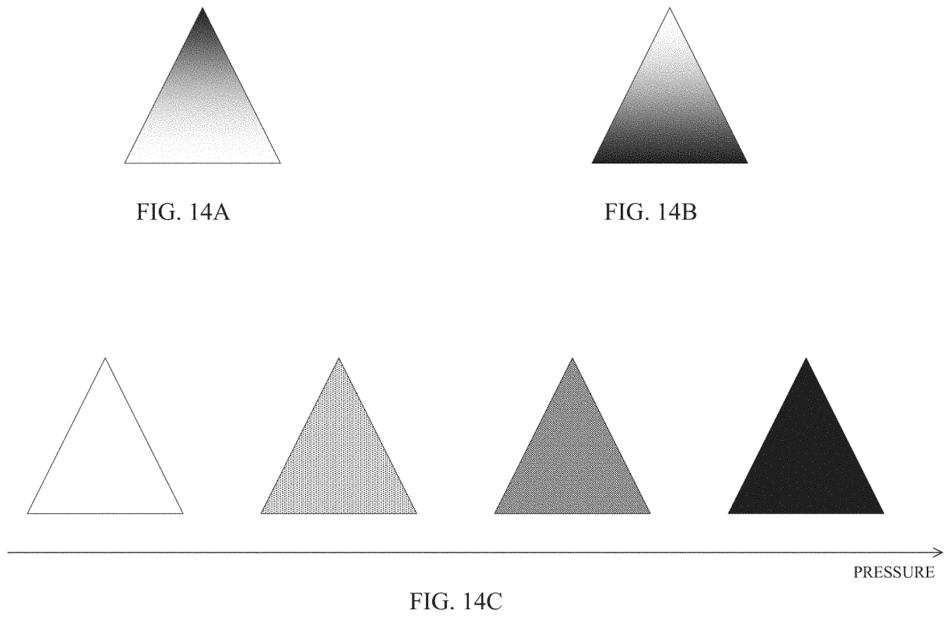

Please refer to FIGS. 14A˜C, which show diagrams of erasing probability variations inside erasing areas according to embodiments of the present invention. In these three diagrams, darker color represents larger erasing probability. Regarding to the erasing area as shown in FIG. 14A, the erasing probability at the tip is the largest. The farther away from the tip, the smaller the erasing probability. Reversely, regarding to the erasing area as shown in FIG. 14B, the erasing probability at the tip is the smallest. The closer to the tip, the smaller the erasing probability. In the embodiments as shown in FIGS. 14A and 14B, the variation rate of the erasing probabilities is linear. However, the present application does not limit that the variation of the erasing probabilities is linear.

The maximum value and/or the minimum value of the erasing probability may be configurable. Alternatively, the maximum value of the erasing probability may be set corresponding to the pressure to the erasing electrode 341. In one embodiment, the erasing area may have an identical erasing probability. The maximum of the erasing probability is set according to the pressure to the erasing electrode 341. The erasing probability is set between 0%˜100%.

Regarding to the four embodiments as shown in FIG. 14C, the erasing probability inside each of the erasing areas is identical. The erasing probability of the erasing area is set according to the pressure to a corner in contact with the touch screen 120. The most right erasing area is corresponding to the largest pressure; and the most left erasing area is corresponding to the smallest pressure.

Person having ordinary skill in the art can understand that the pressure to the erasing electrode 341 is equivalent to the pressure to the corresponding corner which contacts the touch screen 120 in the present application. And according to Newton's third law, action and opposition re-action, it is also equivalent to the pressure to the touch screen 120 from the corner of the electronic board eraser 115.

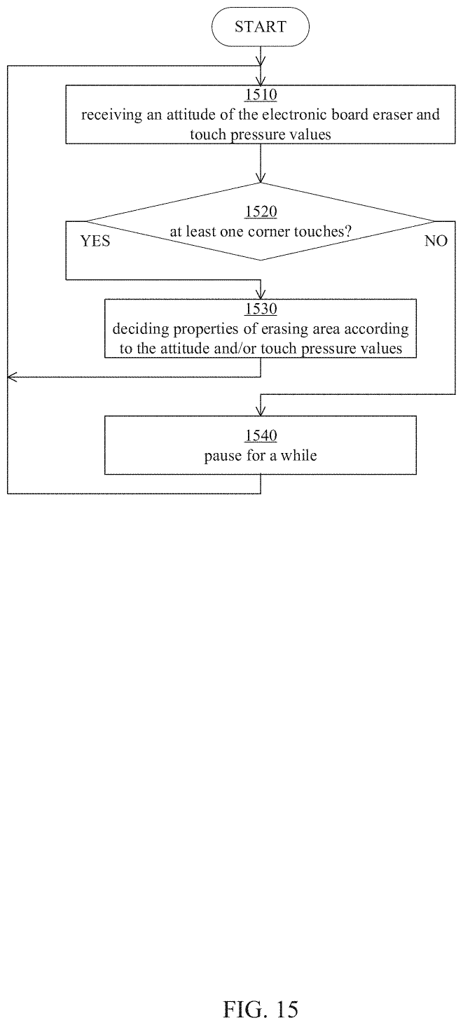

Please refer to FIG. 15, which shows a flowchart of a method for setting an eraser area according to an embodiment of the present invention. The method may be applicable to the host 140. The method comprises following steps:

Step 1510: receiving an attitude of the electronic board eraser relative to the touch screen and touch pressure values. The attitude mentioned in the present application refers to a relative position of the electronic board eraser corresponding to the touch screen.

In one embodiment, the host 140 may receive the attitude and the touch pressure values from the touch sensitive processing apparatus 130. The touch sensitive processing apparatus 130 is configured to calculate positions of erasing electrodes by the electrical signals emitted from the erasing electrodes of the electronic board eraser received by touch electrodes of the touch screen 120 and to receive the touch pressure values according to the electrical signals, too. After the touch or approximation positions corresponding to the eraser electrodes are calculated, the attitude of the electronic board eraser relative to the touch screen may be calculated according to the positions corresponding the erasing electrodes of the electronic board eraser.

In one example, the electrical signal emitted by each of the eraser electrodes includes signals with two frequency sets. When a strength ratio between these signals with two frequency sets is a predetermined value, the touch sensitive processing apparatus determines that the eraser electrode is not under pressure. When the strength ratio of these two signals of two frequency sets is not the predetermined value, the touch sensitive processing apparatus determines that the eraser electrode is under pressure. In one example, the electrical signals emitted by the eraser electrodes in a specific period include modulated information of pressure value. The touch sensitive processing apparatus may gather the information of pressure value by demodulating the electrical signal received in the specific period.

In an alternative embodiment, the host 140 may receive at least one or more information of pressure value from the electronic board eraser via wired or wireless channel other than the touch sensitive processing apparatus. The host 140 may calculate the attitude of the electronic board eraser relative to the touch screen according to the positions corresponding to the eraser electrodes which are calculated by the touch sensitive processing apparatus based on the received electrical signals emitted by the eraser electrodes of the electronic board eraser.

Step 1520: determining whether at least one corner of the electronic board eraser contacts the touch screen? The determination may be based on the received touch pressure values. When all of the touch pressure values are zero, it implies that the electronic board eraser does not contact the touch screen. In this case, the flow goes to step 1540. When at least one corner of the electronic board eraser is in contact with the touch screen, the flow goes to step 1530.

Step 1530: deciding the properties of the erasing area according to the attitude and/or the touch pressure values.

In one embodiment, the shape of the erasing area is decided according to how the electronic board eraser contacts the touch screen. For example, if the wiping surface of the electronic board eraser contacts the touch screen, the shape of the erasing area is corresponding to the shape of the wiping surface. If an edge of the wiping surface contacts the touch screen, the shape of the erasing area may be a rectangle. If a corner of the wiping surface is in contact with the touch screen, the shape of the erasing area is a pointing shape. The shape and its pointing direction of the pointing shape are corresponding to the attitude.

In one embodiment, the shape includes an indicating angle, which is set corresponding to the angle between the wiping surface and the touch screen. The angle between the wiping surface and the touch screen is getting larger; the indicating angle is getting smaller.

In one embodiment, the size of the erasing area is corresponding to one or a combination of the following parameters: the angle between the wiping surface and the touch screen; the touch pressure value corresponding to the corner; and an average of touch pressure values of the contacted edge.

In one embodiment, the erasing probability inside the erasing area is identical. In one embodiment, the erasing probability is set corresponding to the touch pressure of the contacted corner.

In one embodiment, the erasing probabilities inside the erasing area are not identical. In one embodiment, the variation of the erasing probabilities is set corresponding to the indicating direction of the pointing shape.

In one embodiment, the pointing shape is asymmetric. In one embodiment, the pointing shape is set corresponding to two angles between two edges adjacent to the contacted corner and the touch screen, respectively.

In one embodiment, if the touch screen is a curve screen, the attitude is corresponding to a local plane when the corner contacts the touch screen.

Step 1540: pause for a while. When the electronic board eraser leaves the touch screen, the touch sensitive processing apparatus may take advantage of the time period to operate in other modes, such as a mode for detecting external conducting object, a mode for detecting stylus, etc.

According to an embodiment of the present invention, a method for setting erasing area is provided. The method comprising: receiving an attitude of an electronic board eraser relative to a touch screen and touch pressure values; determining whether at least one corner of an wiping surface of the electronic board eraser contacts the touch screen; and deciding properties of an erasing area if it is determined that at least one corner of the wiping surface of the electronic board eraser contacts the touch screen.

In one embodiment, in order to more quickly for receiving the attitude and touch pressure values or higher refresh rate of the attitude, the attitude and the touch pressure values are came from a touch sensitive processing apparatus coupled to the touch screen, the touch sensitive processing apparatus is configured to receive electrical signals emitted from eraser electrodes of the electronic board eraser via touch electrodes of the touch screen and to calculate the attitude and the touch pressure values according to the electrical signals and relative positions corresponding to the eraser electrodes.

In one embodiment, in order to support electronic board eraser which is capable of transmitting information via channel other than the touch screen, the method further comprising: receiving the touch pressure values from the electronic board eraser; receiving, from a touch sensitive processing apparatus, touching or approximating events corresponding to eraser electrodes of the electronic board eraser with regard to the touch screen; and calculating the attitude according to the touching or approximating events and relative positions corresponding to the eraser electrodes of the electronic board eraser.

In one embodiment, in order to let the user sets the direction of the erasing area via controlling the attitude of the electronic board eraser, the deciding step further comprises: setting a shape of the erasing area as a pointing shape if it is determined that only one corner of the wiping surface contacts the touch screen, wherein the shape and direction of the pointing shape are corresponding to the attitude.

In one embodiment, in order to let the user sets the erasing area via controlling the attitude of the electronic board eraser, a shape of the erasing area includes an indicating angle for indicating a direction of the erasing area, which is corresponding to an angle between the wiping surface and the touch screen, wherein the angle between the wiping surface and the touch screen is getting larger, the smaller the indicating angle.

In one embodiment, in order to let the user sets the erasing area via controlling the attitude of the electronic board eraser, a size of the erasing area is decided according to one or any combination of following parameters: an angle between the wiping surface and the touch screen; the touch pressure value corresponding to the corner contacts the touch screen; and an average pressure value of an edge of the wiping surface contacts the touch screen.

In one embodiment, in order to let the user sets the erasing probability via controlling the touch pressure, erasing probability inside the erasing area is identical, which is corresponding to the touch pressure value corresponding to the corner contacts the touch screen.

In one embodiment, in order to emulate traditional board eraser, erasing probabilities inside the erasing area are not identical, wherein the erasing probabilities are varied according to the direction of the pointing shape, as described in the embodiments as shown in FIG. 14A or 14B.

In one embodiment, in order to reflect the shape around the corner which contacts the touch screen is asymmetric, the pointing shape is asymmetric, wherein the pointing shape is set according to two angles between two edges, adjacent to the corner, and the touch screen, respectively.

In one embodiment, in order to let the electronic board eraser in use with a curve screen, the attitude is corresponding to a local plane where the corner contacts the touch screen if the touch screen is a curve screen.

According to an embodiment of the present invention, a system for setting erasing area is provided. The system, comprising: a touch sensitive processing apparatus coupled to a touch screen; and a host, coupled to the touch sensitive processing apparatus, configured to execute a program stored in a non-volatile memory for implementing following steps: receiving an attitude of an electronic board eraser relative to the touch screen and touch pressure values; determining whether at least one corner of an wiping surface of the electronic board eraser contacts the touch screen; and deciding properties of an erasing area if it is determined that at least one corner of the wiping surface of the electronic board eraser contacts the touch screen.

In one embodiment, in order to more quickly for receiving the attitude and touch pressure values or higher refresh rate of the attitude, the attitude and the touch pressure values are came from the touch sensitive processing apparatus, which is configured to receive electrical signals emitted from eraser electrodes of the electronic board eraser via touch electrodes of the touch screen and to calculate the attitude and the touch pressure values according to the electrical signals and relative positions corresponding to the eraser electrodes.

In one embodiment, in order to support electronic board eraser which is capable of transmitting information via channel other than the touch screen, the system further comprises: a signal receiver for connecting to the electronic board eraser, the signal receiver is configured to receive the touch pressure values from a signal transmitter of the electronic board eraser, wherein the host, coupled to the signal receiver, is further configured to execute a program stored in a non-volatile memory for implementing following steps: receiving, from the touch sensitive processing apparatus, touching or approximating events corresponding to eraser electrodes of the electronic board eraser with regard to the touch screen; and calculating the attitude according to the touching or approximating events and relative positions corresponding to the eraser electrodes of the electronic board eraser.

In one embodiment, in order to let the user sets the direction of the erasing area via controlling the attitude of the electronic board eraser, the deciding step further comprises: setting a shape of the erasing area as a pointing shape if it is determined that only one corner of the wiping surface contacts the touch screen, wherein the shape and direction of the pointing shape are corresponding to the attitude.

In one embodiment, in order to let the user sets the erasing area via controlling the attitude of the electronic board eraser, a shape of the erasing area includes an indicating angle for indicating a direction of the erasing area, which is corresponding to an angle between the wiping surface and the touch screen, wherein the angle between the wiping surface and the touch screen is getting larger, the smaller the indicating angle.

In one embodiment, in order to let the user sets the erasing area via controlling the attitude of the electronic board eraser, a size of the erasing area is decided according to one or any combination of following parameters: an angle between the wiping surface and the touch screen; the touch pressure value corresponding to the corner contacts the touch screen; and an average pressure value of an edge of the wiping surface contacts the touch screen.

In one embodiment, in order to let the user sets the erasing probability via controlling the touch pressure, erasing probability inside the erasing area is identical, which is corresponding to the touch pressure value corresponding to the corner contacts the touch screen.

In one embodiment, in order to emulate traditional board eraser, erasing probabilities inside the erasing area are not identical, wherein the erasing probabilities are varied according to the direction of the pointing shape.

In one embodiment, in order to reflect the shape around the corner which contacts the touch screen is asymmetric, the pointing shape is asymmetric, wherein the pointing shape is set according to two angles between two edges, adjacent to the corner, and the touch screen, as described in the embodiments shown in FIG. 14A or 14B.

In one embodiment, in order to let the electronic board eraser in use with a curve screen, the attitude is corresponding to a local plane where the corner contacts the touch screen if the touch screen is a curve screen.

In one embodiment, the system further comprises the touch screen and the electronic board eraser.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A method for setting erasing area, comprising:
receiving an attitude of an electronic board eraser relative to a touch screen and touch pressure values;
determining whether at least one corner of an wiping surface of the electronic board eraser contacts the touch screen; and
deciding properties of an erasing area if it is determined that at least one corner of the wiping surface of the electronic board eraser contacts the touch screen.

2. The method of claim 1, wherein the attitude and the touch pressure values are came from a touch sensitive processing apparatus coupled to the touch screen, the touch sensitive processing apparatus is configured to receive electrical signals emitted from eraser electrodes of the electronic board eraser via touch electrodes of the touch screen and to calculate the attitude and the touch pressure values according to the electrical signals and relative positions corresponding to the eraser electrodes.

3. The method of claim 1, further comprising:
receiving the touch pressure values from the electronic board eraser;
receiving, from a touch sensitive processing apparatus, touching or approximating events corresponding to eraser electrodes of the electronic board eraser with regard to the touch screen; and
calculating the attitude according to the touching or approximating events and relative positions corresponding to the eraser electrodes of the electronic board eraser.

4. The method of claim 1, wherein the deciding step further comprises:
setting a shape of the erasing area as a pointing shape if it is determined that only one corner of the wiping surface contacts the touch screen,
wherein the shape and direction of the pointing shape are corresponding to the attitude.

5. The method of claim 1, wherein a shape of the erasing area includes an indicating angle for indicating a direction of the erasing area, which is corresponding to an angle between the wiping surface and the touch screen, wherein the angle between the wiping surface and the touch screen is getting larger, the smaller the indicating angle.

6. The method of claim 1, wherein a size of the erasing area is decided according to one or any combination of following parameters:
an angle between the wiping surface and the touch screen;
the touch pressure value corresponding to the corner contacts the touch screen; and
an average pressure value of an edge of the wiping surface contacts the touch screen.

7. The method of claim 4, wherein erasing probability inside the erasing area is identical, which is corresponding to the touch pressure value corresponding to the corner contacts the touch screen.

8. The method of claim 4, wherein erasing probabilities inside the erasing area are not identical, wherein the erasing probabilities are varied according to the direction of the pointing shape.

9. The method of claim 4, wherein the pointing shape is asymmetric, wherein the pointing shape is set according to two angles between two edges, adjacent to the corner, and the touch screen, respectively.

10. The method of claim 4, wherein the attitude is corresponding to a local plane where the corner contacts the touch screen if the touch screen is a curve screen.

11. A system for setting erasing area, comprising:
a touch sensitive processing apparatus coupled to a touch screen; and
a host, coupled to the touch sensitive processing apparatus, configured to execute a program stored in a non-volatile memory for implementing following steps:
receiving an attitude of an electronic board eraser relative to the touch screen and touch pressure values;
determining whether at least one corner of an wiping surface of the electronic board eraser contacts the touch screen; and
deciding properties of an erasing area if it is determined that at least one corner of the wiping surface of the electronic board eraser contacts the touch screen.

12. The system of claim 11, wherein the attitude and the touch pressure values are came from the touch sensitive processing apparatus, which is configured to receive electrical signals emitted from eraser electrodes of the electronic board eraser via touch electrodes of the touch screen and to calculate the attitude and the touch pressure values according to the electrical signals and relative positions corresponding to the eraser electrodes.

13. The system of claim 11, further comprises:
a signal receiver for connecting to the electronic board eraser, the signal receiver is configured to receive the touch pressure values from a signal transmitter of the electronic board eraser,
wherein the host, coupled to the signal receiver, is further configured to execute a program stored in a non-volatile memory for implementing following steps:
receiving, from the touch sensitive processing apparatus, touching or approximating events corresponding to eraser electrodes of the electronic board eraser with regard to the touch screen; and
calculating the attitude according to the touching or approximating events and relative positions corresponding to the eraser electrodes of the electronic board eraser.

14. The system of claim 11, wherein the deciding step further comprises:
setting a shape of the erasing area as a pointing shape if it is determined that only one corner of the wiping surface contacts the touch screen,
wherein the shape and direction of the pointing shape are corresponding to the attitude.

15. The system of claim 11, wherein a shape of the erasing area includes an indicating angle for indicating a direction of the erasing area, which is corresponding to an angle between the wiping surface and the touch screen, wherein the angle between the wiping surface and the touch screen is getting larger, the smaller the indicating angle.

16. The system of claim 11, wherein a size of the erasing area is decided according to one or any combination of following parameters:
an angle between the wiping surface and the touch screen;
the touch pressure value corresponding to the corner contacts the touch screen; and
an average pressure value of an edge of the wiping surface contacts the touch screen.

17. The system of claim 14, wherein erasing probability inside the erasing area is identical, which is corresponding to the touch pressure value corresponding to the corner contacts the touch screen.

18. The system of claim 14, wherein erasing probabilities inside the erasing area are not identical, wherein the erasing probabilities are varied according to the direction of the pointing shape.

19. The system of claim 14, wherein the pointing shape is asymmetric, wherein the pointing shape is set according to two angles between two edges, adjacent to the corner, and the touch screen.

20. The system of claim 14, wherein the attitude is corresponding to a local plane where the corner contacts the touch screen if the touch screen is a curve screen.

21. The system of claim 11, further comprises the touch screen and the electronic board eraser.
